(19) United States
(12) Patent Application Publication
(10) Pub. No.: US 2024/0152900 A1
(43) Pub. Date: May 9, 2024

(54) Method for contactless communication between a communicating object and a communication device

(71) Applicant: ORANGE, Issy-les-Moulineaux (FR)

(72) Inventors: Emmanuel Le Huerou, CHATILLON CEDEX (FR); François Toutain, CHATILLON CEDEX (FR); Michael Pontiggia, CHATILLON CEDEX (FR)

(21) Appl. No.: 18/567,174

(22) PCT Filed: Jun. 9, 2022
(86) PCT No.: PCT/FR2022/051101

§ 371 Date: Dec. 5, 2023

(30) Foreign Application Priority Data
Jun. 23, 2021 (FR) FR2106702

(51) Int. Cl. G06Q 20/32

(52) U.S. Cl. CPC G06Q 20/3278

(57) ABSTRACT

A method for communication between a communicating object and a communication device in order to implement a transaction. The method includes, on the communicating object located in an area in which the transaction is implemented, autonomous execution of the following: receiving at least one pairing request from one or more pairing devices associated with the area, when the communicating object has determined at least one item of information in relation to the use context of the communicating object and a location associated with at least one of the pairing devices; and when a pairing device identified in the at least one received pairing request corresponds to the at least one pairing device associated with the area and the location associated with the at least one pairing device corresponds to the location of the communicating object in the area, pairing with the communication device, the communication device being associated with the identified pairing device.

### FIELD OF THE INVENTION

The invention relates to contactless communications, that is to say wireless communications, for the transmission of data between a communicating object and a communication device located in radio proximity to this object. More specifically, the invention relates to a system for carrying out banking transactions, access control transactions, transactions for ordering products or services, etc. between this communicating object, such as for example a connected vehicle, a smartphone, a connected watch, and a communication device, such as for example a reader, a point of payment, a gate.

### PRIOR ART

Near-field communications, usually known by the acronym “NFC”, based mainly on the ISO (International Organization for Standardization) 14443 standard, use wireless technologies to allow information to be exchanged between two peripherals separated by a short distance, typically less than ten centimeters. Communications of this type have many applications, for example in the fields of payment or transportation. The near-field receiver receives a message from the near-field transmitter. Such a message may correspond, in the abovementioned context, to the validation of a transaction, such as for example the exchange of a ticket (for an event, for travel, etc.), a payment, the launch of a personalized service on a computer or a television set, access to a room, etc.

At present, a user has the possibility of using a connected object to implement the type of transactions mentioned above rather than conventionally using a bank card, a transport pass, a card for accessing a premises, etc. To this end, the user brings the connected object, for example their connected watch, to within a few centimeters of the antenna of the NFC communication device. Following this approach, the NFC communication device receives the signal from the connected object. The received signal is demodulated and transmitted to an equipment suitable for performing processing operations, in the present case for implementing the transaction (payment, opening a door, etc.).

Considering that such a transaction is initiated by the user, and that it is the user themselves who decides to bring the connected object toward the communication device that they have selected in order to establish a communication, there is little chance of the pairing between the connected object and the communication device encountering any problem, in that the connected object will know how to recognize this communication device from among others in order to initiate pairing correctly. Nevertheless, the user is still obliged to present the connected object close to the communication device in order to initiate pairing prior to the communication between the connected object and the communication device. Such an action is not always convenient, in particular for people with reduced mobility, the elderly, children, etc. With regard to another connected object, typically a connected vehicle, certain contactless communications between the connected vehicle and a communication device are already implemented at present. In the case of accessing a car park, for example, the simple reading, by the communication device, of the license plate or of a specific badge affixed to the windscreen is sufficient to give the vehicle access to the car park. The same applies for allowing the vehicle automatic access at a toll point using a specific badge. Although this type of contactless communication provides ease of use for the user, who no longer needs to stop at the entrance to the car park to take a parking ticket or else to stop at the toll point to pay, this context of contactless communication has a certain number of drawbacks. Indeed, the user is systematically obliged to carry out an action with a service provider (car park manager, motorway company) by creating an account, possibly by paying a subscription over a given period to benefit from the service. This action requires the provision of personal data specific to the user, and said user does not really know how said personal data will be exploited by the service provider. In addition, in the example of access at a toll point, the user is obliged, on their own initiative, to select themselves the appropriate toll barrier, that is to say the one reserved for subscribers, to take their vehicle there, to pair it with a communication device located close to the barrier, in order to be able to pass through this toll point automatically.

### AIM AND SUMMARY OF THE INVENTION

One of the aims of the invention is to address drawbacks of the abovementioned prior art.

To this end, one subject of the present invention relates to a method for contactless communication between a communicating object and a communication device in order to implement a transaction in relation to the provision of a product or a service. Such a method is noteworthy in that it comprises, on the communicating object located in an area in which the transaction is implemented, autonomous execution of the following:
activating the reception of at least one pairing request from one or more pairing devices associated with the area, when the communicating object has determined at least one item of information in relation to the use context of the communicating object and a location associated with at least one pairing device that is associated with the area,
when a pairing device identified in said at least one received pairing request corresponds to said at least one pairing device associated with the area and the location associated with said at least one pairing device corresponds to the location of the communicating object in the area, pairing with the communication device, said communication device being associated with the identified pairing device.

The invention advantageously allows an object able to communicate contactlessly with a communication device, in other words a connected object, such as for example a connected vehicle, a connected watch, a connected badge or a connected transport card, etc., to pair with a communication device, autonomously, appropriately and securely, with a view to communicating with this device in order for example to validate a transaction with this device or execute the order for a product or a service with this device. The communicating object according to the invention executes the pairing autonomously in the sense that no intervention or action on the object by a user is necessary, thereby combining flexibility and ease of use for this user. The pairing, and therefore the communication following this pairing, are secured by the fact that the communicating object that arrives in the area in which the transaction with the communication device is implemented:
listens for pairing requests from one or more pairing devices that has/have been associated beforehand with this area, once the communicating object has determined at least one item of information about its use context and it has correctly determined a location associated with at least one pairing device;
executes the pairing action only if the pairing device identified in the received pairing request actually corresponds to the pairing device associated with the determined location and this location corresponds to that of the object. Thus, any risk for the communicating object of mistakenly pairing with the pairing device, or even another unwanted pairing device from which the communicating object might have received a pairing request, is completely eliminated.

The invention advantageously allows the communicating object to filter the various received pairing requests on its own initiative so as to select the pairing device that is suitable for authorizing the pairing and the triggering of the communication between the communicating object and the communication device associated with this pairing device.

Thus, by virtue of this double level of security applied by the communicating object, the communication method according to the invention is made particularly reliable and efficient.

According to one particular embodiment, the activation of the reception of at least one pairing request is implemented as follows:
comparing a first set of information, including said at least one item of information in relation to the use context of the communicating object and data in relation to the location that has been associated with said at least one pairing device, with at least one second set of reference information that characterizes a pairing situation of a communicating object as being valid,
if there is a match between the first set of information and the second set of information, activating the reception of said at least one pairing request,
if not, preventing the activation of said reception.

This embodiment thus allows the communicating object, by virtue of a particularly simple decision-making mechanism, to activate its pairing means on its own initiative, on the basis only of information determined by the communicating object and when its pairing situation is considered to be favorable, taking into account the information contained in the one and/or more available reference sets. Thus, outside such a valid pairing situation, the communicating object remains in a non-pairing situation by default, thereby making it possible to save the battery of this object.

According to another particular embodiment, the activation of the reception of at least one pairing request is implemented as follows:
combining said at least one item of information in relation to the use context of the communicating object and data in relation to the location associated with said at least one pairing device,
obtaining a score representative of the result of the combination,
comparing the obtained score with a threshold,
depending on the result of the comparison, activating or not activating the reception of at least one pairing request.

This embodiment constitutes a decision-making variant compared to the previous embodiment, with similar advantages. In this variant, a score, for example between 0 and 1, is assigned to the combination of said at least one item of information in relation to the use context of the object and the location data that have been associated beforehand with at least one pairing device. This score is then compared with a reference threshold, for example 0.6, which characterizes a pairing situation that is for example valid above this threshold and a pairing situation that is invalid below this threshold (the opposite is also possible depending on the established comparison convention). If the assigned score is greater than (or greater than or equal to) this reference threshold, the communicating object listens for pairing requests likely to reach it from one or more pairing devices. If the assigned score is less than (or less than or equal to) this reference threshold, the communicating object remains in a non-pairing situation by default.

According to another particular embodiment, the at least one item of information in relation to the use context of the communicating object is representative of an environment in which the communicating object is located or contains at least one operating datum in relation to the communicating object.

The at least one item of use context information, determined fully autonomously by the communicating object, is particularly accurate and reliable since it is related to the very environment in which the communicating object is located and/or is based on operating data in relation to this object.

According to another particular embodiment, the at least one item of use context information representative of an environment in which the communicating object is located is contained in a message received by the communicating object from a pairing device associated with said area or from a message-transmitting device located in said environment, said at least one item of information indicating a location close to the communicating object.

According to another particular embodiment, the at least one item of use context information representative of an environment in which the communicating object is located comprises a geolocation datum in relation to the communicating object with respect to the pairing device associated with said area.

According to another particular embodiment, the at least one item of use context information representative of an environment in which the communicating object is located contains a datum coming from at least one sensor belonging to the communicating object.

According to another particular embodiment, the at least one operating datum in relation to the communicating object contained in the at least one item of use context information is a current operating parameter recorded by the communicating object or an element of a history of the communications or transactions carried out by the communicating object.

According to another particular embodiment, the location of the identified pairing device is determined from a memory of the communicating object.

Such an embodiment advantageously allows the communicating object to have direct access to the location data associated with a pairing device without having to call upon the communication network to obtain these data at the time of pairing, via this pairing device, with the desired communication device or just before this pairing. The pairing device is thus known and referenced in the communicating object before any pairing action between this object and the communication device associated with this pairing device.

The benefit of storing location data associated with the pairing device, and where applicable location data associated with other pairing devices, in advance in the communicating object is that of increasing the security of the pairing, and therefore of the subsequent communication, by avoiding any fraudulent addition of a communication device that is unsolicited because it is not associated with a pairing device known to the communicating object.

According to another particular embodiment, the location associated with said at least one pairing device is determined from the content of a message received from said at least one pairing device or from a message-transmitting device located in the environment of the communicating object.

Such an embodiment advantageously allows the communicating object to have dynamic access:
to the location associated with the pairing device, which is itself associated with the communication device with which the communicating object wishes to communicate, and
to the location data associated with other potential pairing devices, thereby making it possible to save the memory resources of the communicating object while still benefiting from location data that are updated in real time.

The various abovementioned embodiments or implementation features may be added, independently or in combination with one another, to the contactless communication method defined above.

The invention also relates to a communicating object having capabilities for contactless communication with a communication device, in order to implement a transaction in relation to the provision of a product or a service.

Such a communicating object is noteworthy in that it comprises a processor that is configured to implement, on the communicating object located in an area in which the transaction is implemented, autonomous execution of the following:
activating the reception of at least one pairing request from one or more pairing devices associated with the area, when the communicating object has determined at least one item of information in relation to the use context of the communicating object and a location associated with at least one pairing device that is associated with the area,
when a pairing device identified in said at least one received pairing request corresponds to said at least one pairing device associated with the area and the location associated with said at least one pairing device corresponds to the location of the communicating object in the area, pairing with the communication device, said communication device being associated with the identified pairing device.

Such a communicating object is in particular able to implement the abovementioned contactless communication method.

The invention also relates to a contactless communication system.

Such a contactless communication system is noteworthy in that it comprises:
a communicating object implementing the abovementioned contactless communication method,
a communication device associated with a pairing device that is itself associated with the area in which the transaction is implemented.

The invention also relates to a computer program comprising instructions for implementing the contactless communication method according to the invention according to any one of the particular embodiments described above when said program is executed by a processor.

Such instructions may be stored durably in a non-transient memory medium of the communicating object implementing the contactless communication method according to the invention.

This program may use any programming language and be in the form of source code, object code or intermediate code between source code and object code, such as in a partially compiled form, or in any other desirable form.

The invention also targets a computer-readable recording medium or information medium containing instructions of a computer program as mentioned above.

The recording medium may be any entity or device capable of storing the program. For example, the medium may comprise a storage means, such as for example a USB key, such as a ROM, for example a CD-ROM or a microelectronic circuit ROM, or else a magnetic recording means, for example a mobile medium (memory card), a hard disk or an SSD.

Moreover, the recording medium may be a transmissible medium such as an electrical or optical signal, which may be conveyed via an electrical or optical cable, by radio or by other means. The program according to the invention may be, in particular, downloaded over the Internet.

As an alternative, the recording medium may be an integrated circuit in which the program is incorporated, the circuit being designed to execute or to be used in the execution of the abovementioned contactless communication method.

According to one exemplary embodiment, the present technique is implemented by way of software components and/or hardware components. With this in mind, the term “module” may correspond in this document equally to a software component, to a hardware component or to a set of software components and hardware components.

### BRIEF DESCRIPTION OF THE DRAWINGS

Other features and advantages will become apparent on reading particular embodiments of the invention, which are given by way of illustrative and non-limiting examples, and the appended drawings, in which:

FIG. 1A shows a contactless communication system according to a first embodiment of the invention,

FIG. 1B shows a contactless communication system according to a second embodiment of the invention,

FIG. 1C shows a contactless communication system according to a third embodiment of the invention,

FIG. 2 shows a communicating object in one embodiment of the invention,

FIG. 3 shows examples of possible configurations of areas in which contactless communication is implemented,

FIG. 4 shows the main actions implemented in the contactless communication method, according to one particular embodiment of the invention,

FIG. 5A shows a first embodiment of a decision phase implemented in the contactless communication method according to the invention,

FIG. 5B shows a second embodiment of a decision phase implemented in the contactless communication method according to the invention.

### DETAILED DESCRIPTION OF ONE EMBODIMENT OF THE INVENTION

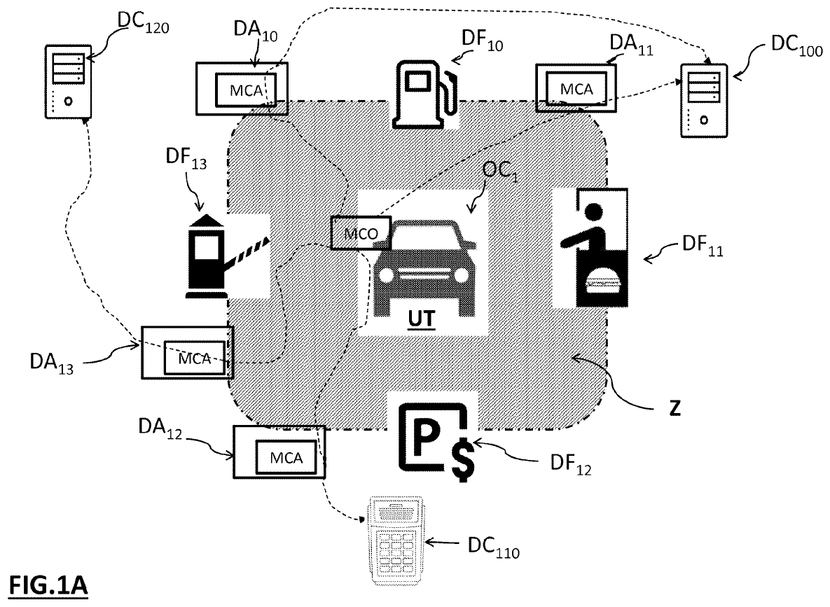

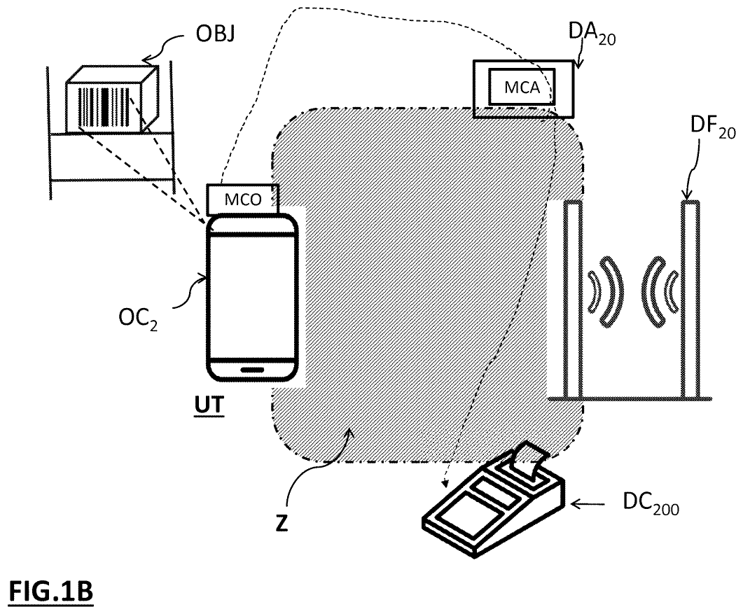

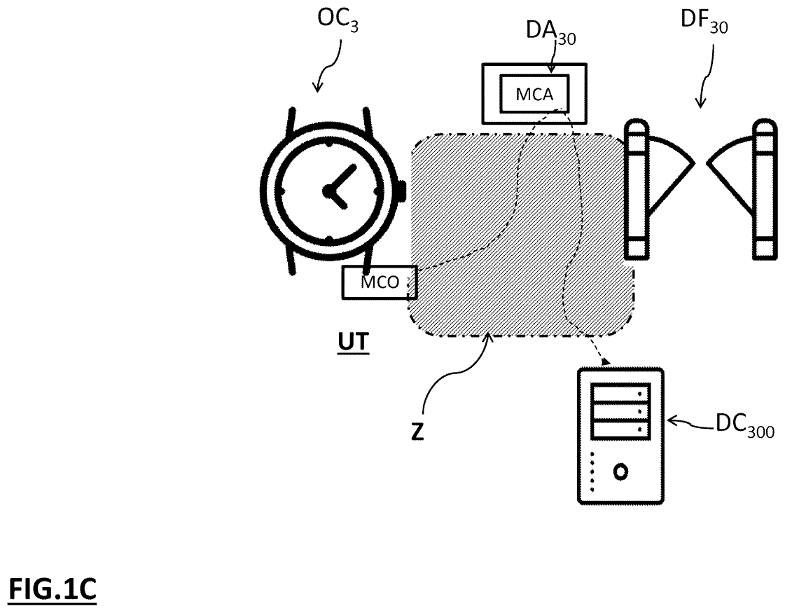

FIG. 1A shows a contactless communication system according to a first embodiment of the invention.

Such a system comprises:
a connected or communicating object OC₁ associated with a user UT, the object OC₁ being equipped with a radio communication module MCO that is configured to communicate using for example short-range radio technology, such as for example NFC, Bluetooth, Wi-Fi, but also long-range radio technology, such as for example 3G, 4G, 5G, etc. or the like,
a provision device DFᵢ (1≤i≤P) for providing a product or a service to the user UT,
a communication device DCⱼ (1≤j≤Q) configured to communicate with the object OC₁ in order to implement a transaction in relation to the provision of a product or a service by the device DFᵢ,
a pairing device DAₖ (1≤k≤R) configured to pair the communicating object OC₁ with one of the Q abovementioned communication devices, and also equipped with a radio communication module MCA corresponding to the radio communication module MCO.

Communicating or connected object is the name given to any object configured to capture data and to communicate with other objects or with dedicated infrastructures using IoT (Internet of Things) technology.

According to the invention:
the contactless communication method is implemented on the communicating object OC₁ that is located in an area Z in which the transaction is implemented,
the pairing device DAₖ is associated with the area Z in a way that will be described later in the description.

In the example of FIG. 1A, the communicating object OC₁ is for example a vehicle, here a car. As such, the car OC₁ is natively equipped with a plurality of sensors/detectors, such as for example a camera, a sensor that detects the level of the car's fuel tank, a speed sensor, a GPS (Global Positioning System) geolocation device, etc.

In the example of FIG. 1A, depending on the use context of the car OC₁, the provision device DFᵢ for providing products or services varies. In a non-exhaustive manner, FIG. 1A shows four different devices DFᵢ:
a petrol pump DF₁₀,
a take-away food kiosk DF₁₁,
a parking meter DF₁₂,
a toll barrier DF₁₃.

Each of the devices DF₁₀ to DF₁₃ is associated with a respective pairing device DA₁₀ to DA₁₃, making it possible to pair, via their respective radio communication module MCA, with the car OC₁, via its corresponding communication module MCO. Such pairing devices DA₁₀ to DA₁₃ are advantageously associated with the area Z. In other words, the pairing devices DA₁₀ to DA₁₃ are not necessarily physically present in the area Z. They may also be located at a distance from or outside this area.

In the example of FIG. 1A, depending on the use context of the car OC₁, the communication device DCⱼ also varies. In a non-exhaustive manner, FIG. 1A shows three examples of communication devices DCⱼ:
the communication device DC₁₀₀, which is a payment server,
the communication device DC₁₁₀, which is a payment terminal, for example an EPT for “electronic payment terminal”,
the communication device DC₁₂₀, which is an access control server or a payment server.

In a use context of a service station, for which the user UT is able to procure fuel from the device DF₁₀ but also to purchase food to take away from the device DF₁₁, the payment server DC₁₀₀ may for example be shared between the devices DF₁₀ and DF₁₁. In the example shown, the payment server DC₁₀₀ is remote from the devices DF₁₀ and DF₁₁. According to various possible implementations, the pairing devices DA₁₀ and DA₁₁ associated with the area Z may or may not be contained in the payment server DC₁₀₀, may or may not be contained in the fuel pump DF₁₀ and the take-away food kiosk DF₁₁, respectively, or may be located outside the area Z. Thus, when the car OC₁ is parked at the fuel pump DF₁₀ in order for the user UT to refuel, once pairing between the car OC₁ and the pairing device DA₁₀ has been carried out, the car OC₁ is then able to be connected to the payment server DC₁₀₀ associated with the pairing device DA₁₀, as shown in dotted lines in FIG. 1A, in order to implement a transaction, here a payment, in connection with the filling of the fuel tank of the car OC₁, and not a payment in connection with the purchase of food to take away from the kiosk DF₁₁, which is not associated with the pairing device DA₁₀, but with the pairing device DA₁₁.

Similarly, when the car OC₁ is parked at the kiosk DF₁₁ in order for the user UT to pick up food to take away, once pairing has been carried out between the car OC₁ and the pairing device DA₁₁, the car OC₁ is then able to be connected to the communication device DC₁₀₀ associated with the pairing device DA₁₁, as shown in dotted lines in FIG. 1A, in order to implement a transaction, here a payment, in relation to the delivery of the food to take away. Such a transaction may for example be implemented by way of an eSIM (embedded subscriber identification module) card installed in the car, an electronic wallet (e-wallet) embedded in the computing infrastructure of the car and in which one or more bank card digital currency units (tokens) have been preloaded, etc.

In the case of the use context of the parking meter DF₁₂ in FIG. 1A, once pairing has been carried out between the car OC₁ and the pairing device DA₁₂, the car OC₁ is then able to be connected to the payment terminal DC₁₁₀ associated with the pairing device DA₁₂, as shown in dotted lines in FIG. 1A, in order to implement a bank transaction in relation to the parking of the car OC₁. In this example, the payment terminal DC₁₁₀ is integrated into the parking meter DF₁₂ or located close thereto.

According to various possible implementations, the pairing device DA₁₂ associated with the area Z may or may not be contained in the payment terminal DC₁₁₀, may or may not be contained in the parking meter DF₁₂, or may be located outside the area Z.

In the case of the use context of the toll point DF₁₃ in FIG. 1A, once pairing has been carried out between the car OC₁ and the pairing device DA₁₃, the car OC₁ is then able to be connected to the access control server or the payment server DC₁₂₀ associated with the pairing device DA₁₃, as shown in dotted lines in FIG. 1A, in order to implement a transaction in relation to the access control of the car OC₁ or to the payment, and then access the toll point with the car OC₁. In this example, the access control server DC₁₂₀ is remote from the toll point DF₁₃.

According to various possible implementations, the pairing device DA₁₃ associated with the area Z may or may not be contained in the access control server or the payment server DC₁₂₀, may or may not be contained in the barrier or the toll booth DF₁₃, or may be located outside the area Z.

The abovementioned examples are of course non-limiting. In some variants, for example in the use context of the parking meter DF₁₂, said parking meter could form a single entity integrating the pairing device DA₁₂ and the payment terminal DC₁₁₀. FIG. 1B shows a contactless communication system according to a second embodiment of the invention. This second embodiment uses elements common to those of FIG. 1A. For this reason, these elements are designated with the same references.

Such a system comprises:
a connected or communicating object OC₂ associated with a user UT, the object OC₂ being equipped with a radio communication module MCO,
a provision device DF₂₀ for providing a product or a service to the user UT,
a communication device DC₂₀₀ configured to communicate with the object OC₂ in order to implement a transaction in relation to the provision of a product or a service by the device DF₂₀,
a pairing device DA₂₀ configured to pair the communicating object OC₂ with the abovementioned communication device, and also equipped with a radio communication module MCA corresponding to the radio communication module MCO.

According to the invention, the pairing device DA₂₀ is advantageously associated with the area Z, in the sense that it is not necessarily physically present in the area Z. The pairing device DA₂₀ may also be located at a distance from or outside this area. In the example of FIG. 1B, the communicating object OC₂ is an object carried or worn by the user UT, such as for example a smartphone. It could of course, as a variant, be a tablet, a badge, a bracelet, etc.

As such, the smartphone OC₂ is natively equipped with a plurality of sensors/detectors, such as for example a camera, a photographic camera, an accelerometer, a GPS geolocation device, etc.

In the example of FIG. 1B, the use context of the smartphone OC₂ is the purchase of an object OBJ in a shop. To this end, the provision device DF₂₀ for providing products or services is for example the anti-theft gate of the shop.

The anti-theft gate DF₂₀ is associated with the pairing device DA₂₀ allowing pairing, via its radio communication module MCA, with the smartphone OC₂, via the communication module MCO thereof.

In such a context of payment for an object OBJ, the communication device DC₂₀₀ is a payment terminal placed for example close to the anti-theft gate DF₂₀, in particular at the cash register of the shop.

The pairing device DA₂₀ may be contained in the anti-theft gate DF₂₀ or in the payment terminal DC₂₀₀. The pairing device DA₂₀ may also be located elsewhere than in the shop, given that it is associated with the area Z.

Thus, when the user UT is in the shop in order to procure the object OBJ, once pairing has been carried out between the smartphone OC₂ and the pairing device DA₂₀, the smartphone OC₂ is then able to be connected to the payment terminal DC₂₀₀ associated with the pairing device DA₂₀, as shown in dotted lines in FIG. 1B, in order to implement, in the area Z, a transaction, here a payment, that relates to the provision of the object OBJ. Such a transaction is implemented for example by way of a SIM or eSIM card installed in the smartphone, an electronic wallet embedded in the smartphone and in which one or more bank card digital currency units (tokens) have been preloaded, etc.

FIG. 1C shows a contactless communication system according to a third embodiment of the invention. This embodiment uses elements common to those of FIGS. 1A and 1B presented above. For this reason, these elements are designated with the same references.

Such a system comprises:
a connected or communicating object OC₃ associated with a user UT, the object OC₃ being equipped with a radio communication module MCO,
a provision device DF₃₀ for providing a product or a service to the user UT,
a communication device DC₃₀₀ configured to communicate with the object OC₃ in order to implement a transaction in relation to the provision of a product or a service by the device DF₃₀,
a pairing device DA₃₀ configured to pair the communicating object OC₃ with the communication device DC₃₀₀, and also equipped with a radio communication module MCA corresponding to the radio communication module MCO.

According to the invention, the pairing device DA₃₀ is advantageously associated with the area Z, in the sense that it is not necessarily physically present in the area Z. The pairing device DA₃₀ may also be located at a distance from or outside this area.

In the example of FIG. 1C, the communicating object OC₃ is an object carried or worn by the user UT, such as for example a connected watch. It could of course be a tablet, a badge, a bracelet, glasses, etc.

As such, the watch OC₃ is natively equipped with a plurality of sensors/detectors, such as for example a camera, a photographic camera, an accelerometer, a GPS geolocation device, etc.

In the example of FIG. 1C, the use context of the connected watch OC₃ is accessing a means of transport, such as for example the metro, the train, the tram, etc. To this end, the provision device DF₃₀ for providing products or services is the access gate to this means of transport. It may also be a terminal arranged in a bus or a tram, near a platform in a railway station, etc.

The gate DF₃₀ is associated with the pairing device DA₃₀. To this end, the pairing device DA₃₀ may be contained in the pairing device DA₃₀, located close thereto or else at a distance therefrom.

In such a context of accessing a means of transport, the communication device DC₃₀₀ is an access control server.

According to various possible implementations, the pairing device DA₃₀ may be contained in the gate DF₃₀ or in the access control server DC₃₀₀. The pairing device DA₃₀ may also be located elsewhere outside the area Z.

Thus, when the user UT is about to pass through the gate DF₃₀ in order to access a means of transport, once pairing has been carried out between the connected watch OC₃ and the pairing device DA₃₀, the connected watch OC₃ is then able to be connected to the access control server DC₃₀₀ associated with the pairing device DA₃₀, as shown in dotted lines in FIG. 1C, in order to implement, in the area Z, a transaction in relation to the user UT accessing the means of transport, such a transaction being controlling access to the means of transport. Such an access control operation for example decrements one or more digital transport tickets preloaded in an electronic wallet of the connected watch OC₃ in which one or more digital transport tickets (tokens), a particular identifier, etc. have been preloaded. According to another example, the access control server DC₃₀₀ could automatically validate access to the means of transport on the basis of a particular identifier associated with the electronic wallet of the connected watch OC₃.

### Description of One Embodiment of the Communicating Object OC

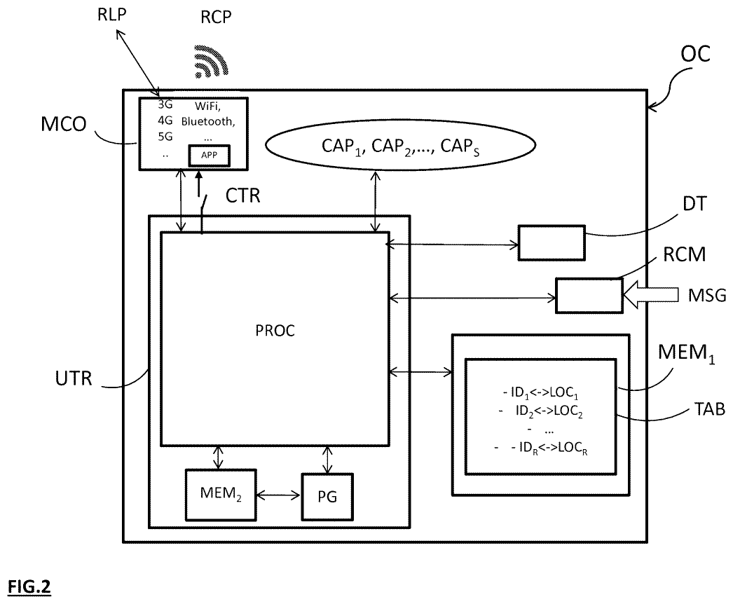

FIG. 2 shows the simplified structure of the communicating object OC, such as for example the object OC₁, OC₂ or OC₃ from FIGS. 1A to 1C, which communicating object is designed to implement the contactless communication method that will be described below.

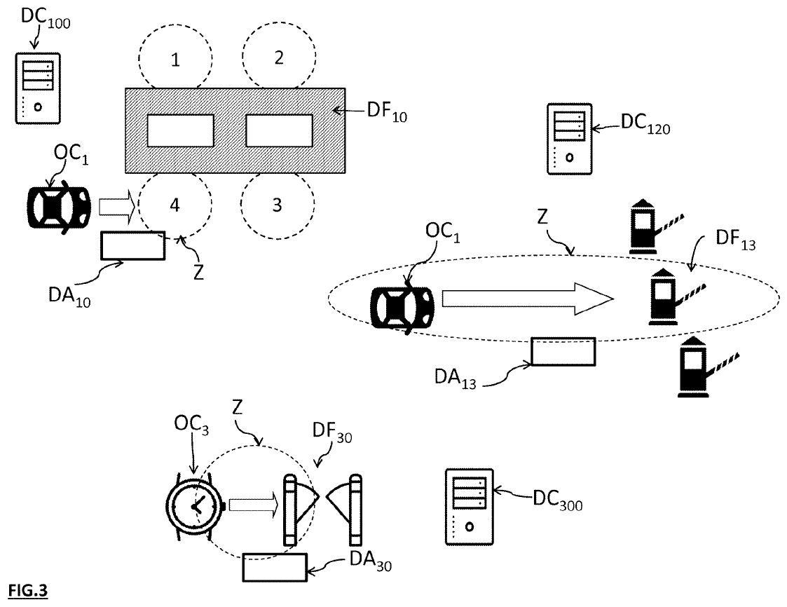

As already explained above, such a communicating object conventionally comprises:
one or more sensors/detectors CAP₁, CAP₂, . . . , CAP_{S} (S≥1),
a reception module RCM for receiving broadcast messages MSG, for example of beacon type or of V2X (Vehicle-to-Everything) type, when the communicating object OC is more particularly a vehicle, these broadcast messages being received from various devices and/or infrastructures that the communicating object encounters on its path,
the communication module MCO, designed to communicate according to the communication context used, via a short-range data network (Bluetooth, Wi-Fi, NFC, etc.), designated by the reference RCP, or via a long-range data network (3G, 4G, 5G, etc.), designated by the reference RLP,
a control module CTR for controlling the activation/deactivation of a reception module APP for receiving, via the data network RLP or RCP, pairing requests from one or more pairing devices DA₁, DA₂, . . . , DA_{R} associated with the area Z,
a transaction device DT, such as for example a SIM card, eSIM card, e-wallet, etc. According to the invention, the communicating object OC comprises a memory MEM₁ that is configured to store, in a table TAB, R identifiers ID₁, ID₂, . . . , ID_{R} in relation to the R pairing devices DA₁, DA₂, . . . , DA_{R}, with respectively R location data LOC₁, LOC₂, . . . , LOC_{R} defining R areas Z. A particular transaction is implemented in each of the R areas Z, as will be described below with reference to FIG. 3. Such location data may be Cartesian, polar, spherical or the like. According to various possible implementations, the location data in relation to the area Z are for example:
a point (latitude, longitude) and the radius of this area, if said area is circular,
two points (latitude, longitude) and a distance between these two points, if the area has the shape of an ellipse,
three points (latitude, longitude), if the area is triangular,
four points (latitude, longitude), if the area has the shape of a quadrilateral,
etc.,
any number of points defining the perimeter of the area.

As a variant, the memory MEM₁ may be remote in a communication network, a cloud, etc. and be made accessible to the communicating object OC, by way of the communication module MCO or a communication module (not shown) dedicated for this purpose. According to one particular embodiment of the invention, the actions executed by the communicating object OC, in the context of implementing the contactless communication method according to the present invention, are implemented by instructions of a computer program PG. For this purpose, the communicating object OC has the conventional architecture of a computer and comprises in particular a memory MEM₂, a processing unit UTR, equipped for example with a processor PROC, and driven by the computer program PG stored in memory MEM₂. The computer program PG comprises instructions for implementing the actions executed by the communicating object OC when the program is executed by the processor PROC, according to any one of the particular embodiments of the invention.

On initialization, the code instructions of the computer program PG are for example loaded into a RAM memory (not shown), before being executed by the processor PROC. The processor PROC of the processing unit UTR implements in particular the actions of collecting data from the one and/or more sensors CAP₁, CAP₂, . . . , CAP_{S}, the actions of controlling, by way of the module CTR, the activation/deactivation of the reception of pairing requests from the one or more pairing devices DA₁, DA₂, . . . , DA_{R}, the actions of receiving such requests, the actions of storing information in relation to the one or more pairing devices in the table TAB, the actions of selecting the appropriate pairing device with respect to the location of the communicating object, the actions of pairing and then of communicating with a communication device DCⱼ associated with the selected pairing device, according to the instructions of the computer program PG.

### Description of One Embodiment of a Contactless Communication Method

A description will now be given of the sequence of a method for contactless communication between a communicating object OC, such as for example the object OC₁, OC₂ or OC₃ from FIGS. 1A to 1C, and an abovementioned communication device DCⱼ, according to one embodiment of the invention, in order to implement a transaction in relation to the provision of a product or a service generated by a provision device DFᵢ for providing a product or a service.

According to the invention, the communicating object OC is configured such that it autonomously executes the various actions that will be described below in order to communicate contactlessly with the communication device DCⱼ, as if it were the user UT themselves who were implementing this communication with a communication terminal, a badge, a card or the like. Such contactless communication is implemented when the communicating object OC is located in the area Z in which the transaction in relation to the provision of a product or service is implemented.

As may be seen in FIG. 3, the size of the area Z varies according to the type of communicating object and its use context.

For example, if the communicating object is the car OC₁ from FIG. 1A and if the use context of this object is to refuel it at a service station, the area Z is small enough to discriminate a single vehicle, which, in the example of FIG. 3, is the car OC₁ parked at the pump DF₁₀, at location no. 4. According to the invention, location data LOC₁₀ defining location no. 4 will have been associated beforehand with an identifier ID₁₀ of the abovementioned pairing device DA₁₀.

According to another example that is shown, if the communicating object is the car OC₁ from FIG. 1A and if the use context of this object is payment at a toll point DF₁₃, the geographical area Z may be much wider, so as to allow pairing and communication in order to implement payment or access control far enough ahead of the actual passage through the toll point DF₁₃. According to the invention, location data LOC₁₃ defining the area Z will have been associated beforehand with an identifier 1013 of the abovementioned pairing device DA₁₃.

If the communicating object is the connected watch OC₃ from FIG. 1C and if the use context of this object is accessing a means of transport via a gate DF₁₂, the geographical area Z has for example a relatively small extent ranging from a few centimeters to 1 meter in diameter, for example. According to the invention, location data LOC₃₀ defining the area Z will have been associated beforehand with an identifier ID₃₀ of the abovementioned pairing device DA₃₀.

When the geographical area Z is close to other geographical areas, for example the geographical areas delimiting locations no. 1 to 3 of the service station, it is ensured that none of the areas overlap. The identifier of the pairing device DA₁₀ will thus in this use case be associated with location data defining each of these locations. The car OC₁ that enters the area Z is thereby perfectly discriminated with respect to other vehicles likely to park in the neighboring areas, thus allowing the pairing between the car OC₁ and the payment server DC₁₀₀, via the pairing device DA₁₀, to proceed correctly. Moreover, regardless of the use context of the communicating object, it is also ensured that each pairing device is associated with an area Z so as to optimize pairing with the communicating object located in this same area, and therefore the contactless communication that follows between the communicating object and the communication device associated with this pairing device. The location data defining an area Z will therefore be finely selected for this purpose.

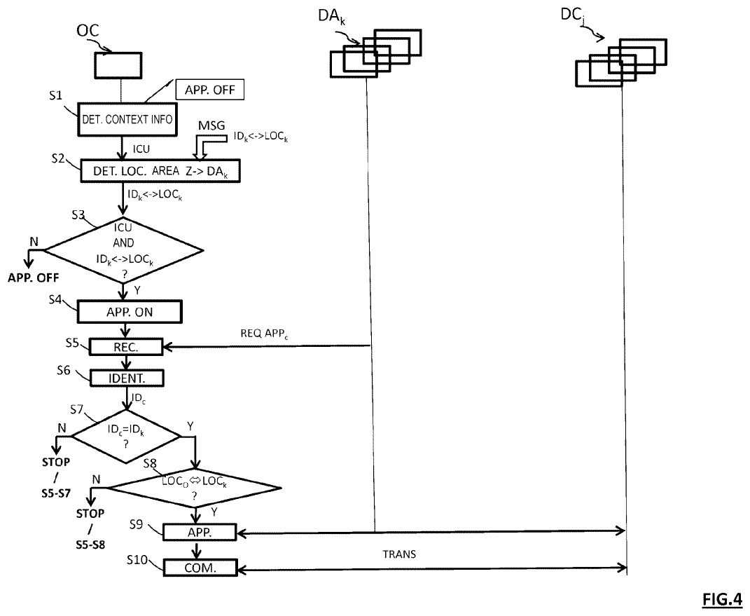

The actions executed by the communicating object OC in order to implement the contactless communication method according to the invention are now illustrated in FIG. 4.

In S1, the communicating object OC, which is moving in the direction of a provision device DFᵢ for providing a product or a service to a user UT of this object, determines one or more items of information ICU in relation to the use context of the communicating object OC.

These one or more items of use context information ICU are representative of an environment in which the communicating object OC is located or contain at least one operating datum in relation to this object. In step S1, the communicating object OC is located in the area Z in which the transaction is implemented.

At this stage, the communicating object OC is not in a situation of communicating with a communication device DCⱼ, the pairing mode of the communication module MCO not being activated (APP. OFF) by the module CTR from FIG. 2.

More specifically and by way of non-exhaustive examples, an item of use context information ICU representative of an environment in which the communicating object OC is located or containing at least one operating datum in relation to this object may be:
an item of information INF₁ contained in a message received by the communicating object OC from for example a pairing device DAₖ or from a message-transmitting device located in the area Z or in the vicinity thereof, this item of information indicating a location close to the communicating object OC, and/or
a geolocation datum INF₂ in relation to the communicating object OC in the area Z, and/or
an item of information INF₃ based on a datum coming from at least one of the sensors CAP₁, CAP₂, . . . , CAP_{S} belonging to the communicating object OC and interpreted thereby, and/or
a current operating parameter INF₄ recorded by the communicating object OC, and/or
an element INF₅ of a history of communications or transactions carried out by the communicating object OC before it reaches the area Z, such as for example the one or more payments previously made by the object OC, the type of product or service paid for, but also the type of transport pass used previously, the one or more toll points used previously, the one or more car parks used previously, etc.

The item of information INF₁ designates for example a particular location corresponding to the area Z, the type of product or service provided by a provision device DFᵢ for providing a product or a service that is located in the area Z, the sign of a store or shop associated with the provision device DFᵢ for providing a product or a service.

In the use context shown in FIG. 1A, in which the communicating object OC is a car OC₁, the item of information INF₁ received by the car OC₁, via the reception module RCM from FIG. 2, is conveyed for example in a message MSG broadcast by one of the pairing devices DA₁₀ to DA₁₃ or by one of the provision devices DF₁₀ to DF₁₃ for providing a product or a service, depending on the use context of the car OC₁. The message MSG may also be broadcast by any appropriate infrastructure, such as a service station that manages all pumps, a restaurant, a traffic control center, a local authority, etc.

Such a message MSG is for example of beacon, V2X, UWB (Ultra-wideband), Wi-Fi multicast, or even Li-Fi (Light Fidelity) type, etc.

Typically, this item of information INF₁ designates for example:
the name of the service station where the pump DF₁₀ is located, the number of this pump, etc.
the type of catering, for example fast food, associated with the take-away food kiosk DF₁₁,
the name of the district or street in which the parking meter DF₁₂ is located,
the town in which the toll point DF₁₃ is located or an identifier of one of the barriers of this toll point.

In the use context shown in FIG. 1B, in which the communicating object OC is a smartphone OC₂, the item of information INF₁ received by the smartphone, via the reception module RCM from FIG. 2, is conveyed for example in a beacon message MSG broadcast by the pairing device DA₂₀, the anti-theft gate DF₂₀, or a transmitter placed at the entrance of the shop, etc. Typically, this item of information INF₁ designates for example the name of the shop, geolocation information in relation to the smartphone OC₂ in the shop, etc.

In the use context shown in FIG. 1C, in which the communicating object OC is a connected watch OC₃, the item of information INF₁ received by the watch, via the reception module RCM from FIG. 2, is conveyed for example in a beacon message MSG or push notification message broadcast by the pairing device DA₃₀, the gate DF₃₀, or a transmitter placed at a railway station or at a station, etc. Typically, this item of information INF₁ designates for example the name of a bus/tram station or stop, the identifier of a transport line, geolocation information in relation to the connected watch OC₃ in the railway station or the station, etc.

With regard to the item of information INF₃, in the use context shown in FIG. 1A, in which the communicating object OC is a car OC₁, the item of information INF₃ corresponds for example to a sign of the service station, of the fast-food establishment, to the name of the car park or of the toll point, etc. that have been recognized after analyzing an image or video captured by one of the sensors CAP₁, CAP₂, . . . , CAP_{S} of the car OC₁, typically a photographic camera or a camera. This may also involve metadata associated with this image, such as for example the geographical position of the service station, of the fast-food establishment, of the car park or of the toll point, the date and/or the time of capture of the image or video. The item of information INF₃ also corresponds, in this use context, to the geographical coordinates (Cartesian, polar, spherical, etc.) of the car OC₁ that are measured by one of the sensors CAP₁, CAP₂, . . . , CAP_{S} of the car OC₁, typically a GPS device.

In the use context shown in FIG. 1B, in which the communicating object OC is a smartphone OC₂, the item of information INF₃ corresponds for example to the type of object OBJ recognized after analyzing a barcode or QR code (Quick Response Code) scanned beforehand by the user UT using the smartphone OC₂, via one of the sensors CAP₁, CAP₂, . . . , CAP_{S} of the smartphone OC₂, typically a scanner. The item of information INF₃ also corresponds, in this use context, to the geographical coordinates (Cartesian, polar, spherical, etc.) of the smartphone OC₂ that are measured by one of the sensors CAP₁, CAP₂, . . . , CAP_{S} of the smartphone OC₂, typically a GPS device.

In the use context shown in FIG. 1C, in which the communicating object OC is a connected watch OC₃, the item of information INF₃ corresponds for example to the name of the station or of the railway station, to an identifier of the transport line taken by the user UT, etc. that have been recognized after analyzing an image or video captured by one of the sensors CAP₁, CAP₂, . . . , CAP_{S} of the watch OC₃, typically a photographic camera or a camera. This may also involve metadata associated with this image, such as the geographical position of the station or of the railway station, the date and/or the time of capture of the image or video. The item of information INF₃ may also correspond, in this use context, to a speed measured by one of the sensors CAP₁, CAP₂, . . . , CAP_{S} of the watch OC₃, typically an accelerometer. The item of information INF₃ also corresponds, in this use context, to the geographical coordinates (Cartesian, polar, spherical, etc.) of the watch OC₃ that are measured by one of the sensors CAP₁, CAP₂, . . . , CAP_{S} of the watch OC₃, typically a GPS device. The operating parameter INF₄ corresponds, more particularly in the use context of FIG. 1A, in which the communicating object OC is a car OC₁, to the parameters related to the infrastructure of the car OC₁ and fed back via a multiplexer or a data bus installed in the car. This involves for example the current speed, the opening/closing of the fuel flap, the decrease/increase in the fuel level in the tank, the opening/closing of a door, etc.

With reference again to FIG. 4, in S2, the communicating object OC, which is moving in the direction of a provision device DFᵢ for providing a product or a service to a user UT of this object, determines the location of the geographical area Z associated with at least one pairing device DAₖ. To this end, according to a first embodiment, when the communicating object OC arrives in the area Z, or slightly before it arrives, it stores the following beforehand in the table TAB stored in memory MEM₁ (FIG. 2), for each pairing device DAₖ associated with the area Z:
the identifier ID₁ of the pairing device DA₁ in association with location data LOC₁ in relation to a given area Z, in which a transaction involving the pairing device DA₁ is implemented,
. . . ,
the identifier ID_{R} of the pairing device DA_{R} in association with location data LOC_{R} in relation to a given area Z, in which a transaction involving the pairing device DA_{R} is implemented.

The information in this table TAB is received using a geolocation technique for geolocating the communicating object OC in its close environment. This information is also secured appropriately in order to counter fraud through the addition of a fake pairing device.

According to a second embodiment, the identifier IDₖ, along with the location data LOCₖ in relation to the area Z associated with the pairing device DAₖ, are obtained dynamically by the communicating object OC so as to preserve the resources of the memory MEM₁. This information is received by the reception module RCM of the communicating object OC (FIG. 2) in the form of a beacon or push notification, or UWB, or Wi-Fi multicast message, or using Li-Fi technology, regardless of the communicating object under consideration among the objects OC₁, OC₂, OC₃, or a V2X message if the object OC is more specifically a vehicle OC₁. The identifier IDₖ, along with the location data LOCₖ that are received, are also secured for the same reasons as in the first embodiment, for example by way of one or more certificates verifiable with an authority.

For a pairing device DAₖ thus referenced by the communicating object OC in the table TAB or obtained dynamically, associated information may also be available, such as for example:
a public key for decrypting the transaction messages that will be transmitted during the contactless communication between the communicating object OC and the communication device DCᵢ associated with the pairing device DAₖ under consideration,
possibly an item of information in relation to a category of a product or a service liable to be billed or used during the transaction (service station category, fast food category, car park category, toll point category, bus, metro, train, tram category, “telephony”, “book store” shop category, etc.).

A pairing device DAₖ under consideration, and therefore the provision device DFᵢ for providing products and services and the communication device DCⱼ that are associated therewith, correspond to a precise geolocation of the area Z, on the centimeter scale, which is obliged passage of the communicating object OC before or after provision of the service or product. The centimeter-level accuracy able to be achieved at present optimizes the localization of the communicating object OC in the area Z associated with the pairing device DAₖ, for example via UWB, RTK (Real-Time Kinematic)-GPS technologies or any other technique that makes it possible to perform localization in space. Thus, in the case for example of FIG. 3, the car OC₁ is able to be located, to within a centimeter, in the area Z (location no. 4) associated with the pairing device D10. In the case of FIG. 1B, the smartphone OC₂ is able to be located in the area Z associated with the pairing device D₂₀ to within a centimeter, at the anti-theft gate D₂₀. In the case of FIG. 1C, the connected watch OC₃ is able to be located, to within a centimeter, in the area Z associated with the pairing device D₃₀, at the access gate DF₃₀.

In S3 in FIG. 4, the communicating object OC checks whether at least one item of context information ICU and the location LOCₖ of an area Z associated with at least one pairing device DAₖ have been determined. If the result of this analysis is negative (N in FIG. 4), the pairing mode of the communication module MCO remains deactivated (APP. OFF). The communicating object OC is therefore not able to receive pairing requests from pairing devices, this constituting a first level of security of the method for contactless communication for the communicating object OC with a communication device DCⱼ, thereby preventing the communicating object OC from mistakenly or fraudulently pairing with such a communication device.

If the result of this analysis is positive (Y in FIG. 4), the pairing mode of the communication module MCO is activated (APP. ON) in S4 by the control module CTR from FIG. 2. At the end of step S4, the communicating object OC then listens for the reception of pairing requests, via the module APP from FIG. 2. A pairing request contains an identifier of the pairing device transmitting this request.

Steps S2 and S3 may be simultaneous. For example, with reference to FIG. 1A, in the use context of a pump DF₁₀ at a service station, of purchasing take-away food at a kiosk DF₁₁, of using a parking meter DF₁₂, it is necessary for the car OC₁ to be stationary (zero speed) at the pump DF₁₀, the kiosk DF₁₁ or the parking meter DF₁₂. Similarly, with reference to FIG. 1C, in the case of accessing a means of transport via the gate DF₃₀, it is necessary for the user UT to stop for a time before passing through the gate DF₃₀, meaning that the speed of the connected watch OC₃ is zero at this precise moment. Thus, insofar as the context information ICU determined in S1 includes, in the case of FIG. 1A, an item of location information in relation to the car OC₁ in radio proximity to the pump DF₁₀, the kiosk DF₁₁ or the parking meter DF₁₂ or, in the case of FIG. 1C, an item of location information in relation to the connected watch OC₃ in radio proximity to the gate DF₃₀, the conditions are considered to be met for passing to abovementioned step S4. Regardless of the envisaged use context or the type of communicating object OC, such location information may form part of the use context information ICU determined in S1. In the case of FIG. 1A, involving for example the car OC₁ that is located at the pump DF₁₀ or at the kiosk DF₁₁, a particular ground marking in the area Z could be detected by the car OC₁, thereby generating location information in relation to the car OC₁ in proximity to the pump DF₁₀ or to the kiosk DF₁₁.

In S5, the communicating object OC receives a pairing request REQ APP_{c} from at least one pairing device DA_{c}, with 1≤c≤R. Such a request contains an identifier ID_{c} of the pairing device DA_{c}.

In S6, the communicating object OC identifies the pairing device DA_{c} by virtue of the identifier ID_{c} contained in the request REQ APP_{c}. During this step, the communicating object OC also uses the encryption key associated with the identifier ID_{c} in the table TAB from FIG. 2 or directly in the request REQ APP_{c} if this key is contained therein.

In S7, the communicating object OC compares the identifier ID_{c} with the identifier of at least one pairing device that was obtained in S2. If the identifier ID_{c} does not correspond to any identifier obtained in S2 (N in FIG. 4) and/or if the communicating object OC fails to authenticate the request REQ APP_{c} using the encryption key, the contactless communication method is stopped or else the communicating object OC repeats steps S5 to S7, this constituting a second level of security of the method for contactless communication for the communicating object OC with a communication device DCⱼ, thus preventing the communicating object OC from mistakenly or fraudulently pairing with such a communication device. The contactless communication method is stopped for example when the control module CTR from FIG. 2 deactivates the reception, by the communicating object OC, of pairing requests. If on the other hand the identifier ID_{c} is equal to an identifier IDₖ obtained in S2 (Y in FIG. 4) and the authentication of the request REQ APP_{c} using the encryption key is successful, the communicating object OC compares, in S8, the location data LOCₖ associated with the identifier IDₖ of the pairing device DAₖ with the location data LOC_{O} in relation to the communicating object OC that come from one of the sensors CAP₁, CAP₂, . . . , CAP_{S}. If the location data LOCₖ and LOC_{O} do not match (N in FIG. 4), the communicating object OC is not considered to be in a valid pairing situation. The contactless communication method is therefore stopped or else the communicating object OC repeats steps S5 to S8, this constituting a third level of security of the method for contactless communication for the communicating object OC with a communication device DCⱼ, thus preventing the communicating object OC from mistakenly or fraudulently pairing with such a communication device. If the location data LOCₖ and LOC_{O} match (Y in FIG. 4), the communicating object OC then pairs, in S9, with the communication device DCⱼ, via the pairing device DA_{K} that is associated therewith.

The comparison S8 between the location data LOCₖ associated with the identifier IDₖ of the pairing device DAₖ and the location data LOC_{O} in relation to the communicating object OC may take various forms depending on the nature of the location data. According to one example:
the location data LOC_{O} in relation to the communicating object comprise the coordinates of a characteristic point of the object, for example its geometric center,
the location data LOCₖ comprise the coordinates defining the perimeter of the area Z.

In this case, the comparison S8 checks whether or not this characteristic point is contained within the area defined by the location data LOCₖ.

According to another example:
the location data LOC_{O} in relation to the communicating object comprise the coordinates defining the perimeter of an area Z′ in which the communicating object OC is located,
the location data LOCₖ comprise the coordinates defining the perimeter of the area Z.

In this case, the S8 comparison checks:
whether or not the area Z′ is contained within the area Z, or vice versa,
whether or not the areas Z′ and Z overlap,
whether or not the areas Z′ and Z are juxtaposed,
etc.

Once pairing has been carried out in S9, contactless communication S10 is then implemented in a conventional manner between the communicating object OC and the communication device DCⱼ in order to implement a transaction (payment, access control, etc.) in relation to the provision of a product or a service.

The steps of the contactless communication method that have just been described above advantageously allow any connected object to communicate contactlessly, completely autonomously and securely, with a communication device (payment server, access control server or gate, cash register in a shop, a kiosk or a toll point, etc.), whether this communication device is close to or far from the connected object.

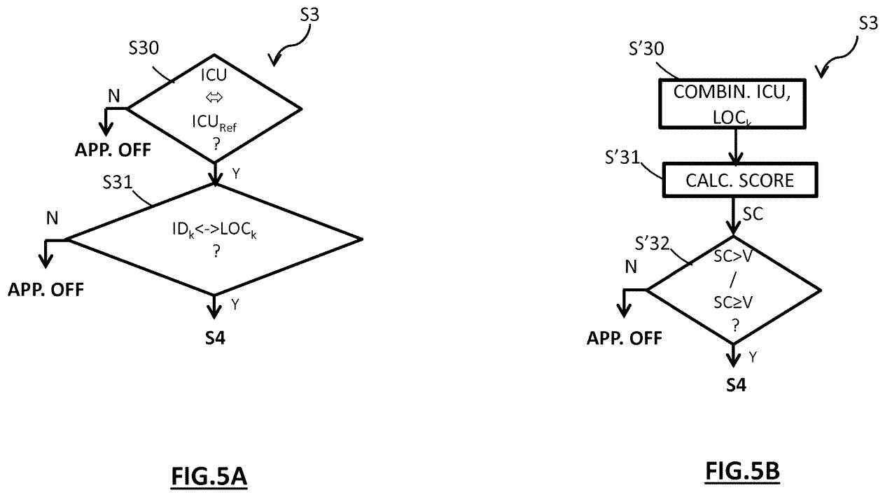

A description will now be given, with reference to FIG. 5A, of a first embodiment of a decision-making phase implemented during step S3 of FIG. 4 in order to characterize that the use context information ICU determined in S2 is indeed representative of a potential legitimate pairing situation of the communicating object OC.

Such a phase comprises a step S30 during which the use context information ICU is compared with reference use context information ICU_{Req} characterizing a pairing situation of a communicating object as being valid and that has been learned beforehand, for example with the aid of a neural network.

If the use context information ICU and the reference use context information ICU_{Ref} do not match (N in FIG. 5A), step S4 of activating reception of pairing requests is not triggered.

If the use context information ICU and the reference use context information ICU_{Ref} match (Y in FIG. 5A), it is checked in S31 whether an area Z associated with a pairing device DAₖ has been correctly located by the communicating object OC, either dynamically with the aid of one or more broadcast messages mentioned above, or with the aid of the information stored in the correspondence table TAB from FIG. 2. If so, step S4 of activating reception of pairing requests is triggered. If not, this step S4 is not triggered.

In the use context of FIGS. 1A and 3, in which the communicating object OC is a car OC₁ that for example refuels at the pump DF₁₀, the determined use context information ICU is for example:
the speed of the car OC₁ is zero,
the engine of the car OC₁ is switched off,
the fuel tank level is low,
the category “fuel pump” is identified in a message MSG.

This information is compared with a learning situation that has been modeled with reference use context information ICU_{Ref} of the same type as or a type similar to the use context information ICU and that has already been evaluated beforehand in an identical or similar use context:
for the car OC₁, or
for another car or any other type of vehicle belonging for example to a fleet of vehicles to which the car OC₁ belongs.

Thus, if in S30 all of the use context information ICU matches the reference use context information ICU_{Ref}, it is checked in S31 whether the car OC₁ has correctly obtained beforehand, in S2 (FIG. 4) from the table TAB or from a message MSG, the location data LOC₁₀ in relation to the area Z associated with the pairing device D10. If so, step S4 of activating reception of pairing requests is triggered. If not, this step S4 is not triggered.

If, on the other hand, the determined use context information ICU is for example:
the speed of the car OC₁ is zero,
the engine of the car OC₁ is switched off,
the fuel tank level is low,
the category “fast food” is identified in a message MSG,
   then, in the comparison step S30, this use context information ICU will not be consistent with the reference use context information ICU_{Ref} modeling a known or learned situation that the car OC₁ is in. Step S4 of activating reception of pairing requests will therefore not be triggered.

In the use context of FIG. 1B, in which the communicating object OC is a smartphone OC₂, the determined use context information ICU is for example:
the type of the scanned object OBJ, and/or
the sign of the shop that sells the object OBJ, and/or
tracking information in relation to the geolocation of the smartphone OC₂ in the shop that indicates that the smartphone OC₂ is present in the area Z associated with the pairing device DA₂₀, and/or
data from the browsing history of the smartphone OC₂ showing that the user UT sought to obtain information about the object OBJ,
etc.

These one or more items of information are compared with a learning situation that has been modeled with one or more items of reference use context information ICU_{Ref} of the same type as or a type similar to the use context information ICU and that has already been evaluated beforehand in an identical or similar use context that defines the purchasing habits of the user UT or of another user or else known purchase kinematics of the user UT or of another user.

In the use context of FIG. 1C, in which the communicating object OC is a connected watch OC₃, the determined use context information ICU is for example:
the name of the bus stop,
geolocation data in relation to the connected watch with respect to this stop,
the identifier of the line that is indicated for example on the approaching bus,
a decreasing speed of the connected watch,
etc.

This information is compared with a learning situation that has been modeled with reference use context information ICU_{Ref} of the same type as or a type similar to the use context information ICU and that has already been evaluated beforehand in an identical or similar use context of a means of transport and representative of the public transport travel habits of the user UT or of another user.

A description will now be given, with reference to FIG. 5B, of a second embodiment of a decision-making phase implemented during step S3 of FIG. 4 in order to characterize that the use context information ICU determined in S2 is indeed representative of a potential legitimate pairing situation of the communicating object OC.

Such a phase comprises a step S′30 during which the one or more items of use context information ICU is or are combined with the location data LOCₖ in relation to an area Z associated with the pairing device DAₖ, these location data LOCₖ having been obtained in S2 in FIG. 4.

In S′31, a score SC is calculated in relation to this combination.

In S′32, the score SC is compared with a threshold TH.

According to one embodiment, 0≤TH≤1. Other bounding values are of course possible depending on the implementation of the rules engine implementing the decision phase, for example via an expert system. One convention establishes for example that, beyond a certain reference value V of the threshold TH, for example equal to 0.6, the communicating object OC is in a valid pairing situation. If SC>V (or SC≥V according to the established convention), step S4 of activating reception of pairing requests is triggered. If S≤V (or SC<V according to the established convention), step S4 of activating reception of pairing requests is not triggered.

1. A method for contactless communication between a communicating object and a communication device in order to implement a transaction, wherein the method comprises, on the communicating object located in an area in which said transaction is implemented, autonomous execution of the following:
receiving at least one pairing request from one or more pairing devices associated with said area, in response to the communicating object having determined at least one item of information in relation to a use context of the communicating object and a location associated with at least one of the pairing devices; and
in response to a pairing device identified in said at least one received pairing request corresponding to said at least one pairing device associated with said area and the location associated with said at least one pairing device corresponding to the location of the communicating object in said area, pairing with the communication device, said communication device being associated with the identified pairing device.

2. The method as claimed in claim 1, comprising activation of the reception of the at least one pairing request by:
comparing a first set of information, including said at least one item of information in relation to the use context of the communicating object and data in relation to said location that has been associated with said at least one pairing device, with at least one second set of reference information that characterizes a pairing situation of a communicating object as being valid, and
at an end of said comparison, establishing that there is a match between the first set of information and the second set of information.

3. The method as claimed in claim 1,
comprising activation of the reception of the at least one pairing request by:
combining said at least one item of information in relation to the use context of the communicating object and data in relation to said location associated with said at least one pairing device,
obtaining a score representative of a result of the combination,
comparing the obtained score with a threshold, and
depending on the result of the comparison, activating the reception of the at least one pairing request.

4. The method as claimed in claim 1, wherein the at least one item of information in relation to the use context of the communicating object is representative of an environment in which the communicating object is located or contains at least one operating datum in relation to the communicating object.

5. The method as claimed in claim 4, wherein the at least one item of use context information representative of an environment in which the communicating object is located is contained in a message received by the communicating object from the pairing device associated with said area or from a message-transmitting device located in said environment, said at least one item of information indicating a location close to the communicating object.

6. The method as claimed in claim 4, wherein the at least one item of use context information representative of an environment in which the communicating object is located comprises a geolocation datum in relation to the communicating object with respect to the pairing device associated with said area.

7. The method as claimed in claim 4, wherein the at least one item of use context information representative of an environment in which the communicating object is located contains a datum coming from at least one sensor belonging to the communicating object.

8. The method as claimed in claim 4, wherein the at least one operating datum in relation to the communicating object contained in the at least one item of use context information is a current operating parameter recorded by the communicating object or an element of a history of the communications or transactions carried out by the communicating object.

9. The method as claimed in claim 1, wherein the location of the identified pairing device is determined from a memory of the communicating object.

10. The method as claimed in claim 1, wherein the location associated with said at least one pairing device is determined from a content of a message received from said at least one pairing device or from a message-transmitting device located in the environment of the communicating object.

11. A communicating object having capabilities for contactless communication with a communication device, in order to implement a transaction, wherein said communicating object comprises:
a processor that is configured to implement, on the communicating object located in an area in which said transaction is implemented, autonomous execution of the following:
receiving at least one pairing request from one or more pairing devices associated with said area, in response to the communicating object having determined at least one item of information in relation to the use context of the communicating object and a location associated with at least one of the pairing devices; and
in response to a pairing device identified in said at least one received pairing request corresponding to said at least one pairing device associated with said area and the location associated with said at least one pairing device corresponding to the location of the communicating object in said area, pairing with the communication device, said communication device being associated with the identified pairing device.

12. (canceled)

13. A computer-readable information medium comprising instructions of a computer program stored thereon which when executed by at least one processor of a communicating object configure the communicating object to implement a method for contactless communication between the communicating object and a communication device in order to implement a transaction, wherein the method comprises, on the communicating object located in an area in which said transaction is implemented, autonomous execution of the following:
receiving at least one pairing request from one or more pairing devices associated with said area, in response to the communicating object having determined at least one item of information in relation to a use context of the communicating object and a location associated with at least one of the pairing devices; and
in response to a pairing device identified in said at least one received pairing request corresponding to said at least one pairing device associated with said area and the location associated with said at least one pairing device corresponding to the location of the communicating object in said area, pairing with the communication device, said communication device being associated with the identified pairing device.

14. A contactless communication system comprising:
the communicating object as claimed in claim 11, and
the communication device.
